(19) United States
(12) Patent Application Publication
(10) Pub. No.: US 2026/0062537 A1
(43) Pub. Date: Mar. 5, 2026

(54) COMPOSITION, MEMBER, STRUCTURAL MATERIAL, OBJECT, AND PROTECTIVE GARMENT

(71) Applicant: CANON KABUSHIKI KAISHA, Tokyo (JP)

(72) Inventor: RYOSHU IURA, Tochigi (JP)

(21) Appl. No.: 19/311,497

(22) Filed: Aug. 27, 2025

(30) Foreign Application Priority Data
Sep. 4, 2024 (JP) 2024-152107

(51) Int. Cl. C08K 3/36; C09D 5/32; C09D 7/61

(52) U.S. Cl. CPC C08K 3/36; C09D 5/32; C09D 7/61; C08K 2201/003; C08K 2201/014

(57) ABSTRACT

A composition contains a resin, 39 vol % or more cerium oxide, and silica.

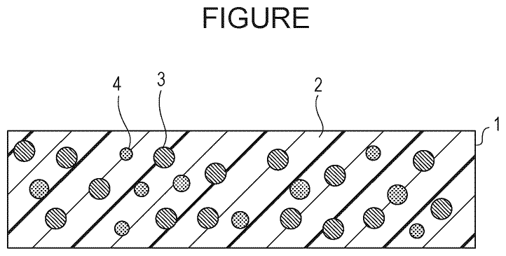

### BACKGROUND

### Field of the Technology

The present disclosure relates to a composition, a member, a structural material, an object, and a protective garment.

### Description of the Related Art

In recent years, the aerospace industry has continued to grow, and opportunities for human activity in the space environment have also increased. In the space environment, it is important to shield radiation, including X-rays traveling through space, in order to reduce radiation dose. Accordingly, the development of materials that can reduce radiation dose in such space environments has been actively pursued.

Japanese Patent Laid-Open No. 2023-7416 proposes a radiation-shielding resin composition containing a binder resin and a shielding material.

### SUMMARY

According to an aspect of the present disclosure, there is provided a composition containing a resin, 39 vol % or more cerium oxide, and silica.

Features of the present disclosure will become apparent from the following description of embodiments with reference to the attached drawing. The following description of embodiments is described by way of example.

### BRIEF DESCRIPTION OF THE DRAWING

FIGURE is a schematic sectional view of a resin composition of an embodiment.

### DESCRIPTION OF THE EMBODIMENTS

Environments such as outer space and high-altitude regions, where radiation exposure to the human body is a concern, are harsh environments characterized by large temperature fluctuations. When existing radiation-shielding resin compositions are applied to substrates formed of alloys or the like, there is concern that such a radiation-shielding resin composition may peel off due to the difference in thermal expansion coefficients between the radiation-shielding resin composition and the substrate.

According to a first aspect of the present disclosure, there is provided a composition that can shield radiation. According to a second aspect of the present disclosure, there is provided a composition that is less likely to peel off or the like even in the case of being applied to a substrate formed of an alloy or the like and used in an environment with large temperature fluctuations.

### Embodiments

A resin composite material according to an embodiment contains a resin, cerium oxide, and silica. This resin composite material is applied to a target object and cured, to thereby form, on the target object, a resin composition 1 containing a resin 2, cerium oxide 3, and silica 4 as illustrated in FIGURE.

The inventor has found that a resin composite material is prepared so as to contain cerium oxide and silica, so that the resin can have high contents of cerium oxide and silica. Specifically, in the case of using such a resin composite material, the resin composition formed by curing on the target object can have a cerium oxide content of 39 vol % or more. The resin composition can have a total content of cerium oxide and silica of 57 vol % or more.

The reason for this is inferred that Ce³⁺ in cerium oxide interacts with O²⁻ of the Si—O—Si bonds in the glass, to thereby enhance the affinity between the particles and the resin.

Such a resin composite material can be applied to a substrate formed of an alloy or the like used for an object that travels through the air or outer space such as an airplane or a satellite. In the case of forming such a resin composition containing cerium oxide and silica and having a film thickness of 1 mm or more on the surface of a target object (substrate), radiation can be shielded and peeling off or the like of the film can be suppressed even under an environment with large temperature fluctuations.

Hereinafter, the embodiment will be described in detail.

### Resin

The resin composite material contains, in addition to cerium oxide and silica, a resin serving as a binder. Any resin may be used as long as it satisfies desired physical properties such as viscosity, such as thermoplastic resins, thermosetting resins, ultraviolet-curable resins, and two-component curable resins. Such resins may be used alone or in combination of two or more thereof.

### Cerium Oxide

The resin composite material contains cerium oxide serving as a radiation-shielding material.

The resin composition that is provided by curing the resin composite material preferably has a cerium oxide content of 39 vol % or more. When this range is satisfied, the resin composition formed by application to the target object can provide sufficient radiation-shielding performance. From the viewpoint of radiation-shielding performance, the resin composition more preferably has a cerium oxide content of 54 vol % or more.

The material of cerium oxide may be any material, such as virgin materials and recycled materials. Such cerium oxide materials may be used alone or in combination of two or more thereof. The cerium oxide preferably has a particle diameter of 2.0 μm or more and 9.0 μm or less.

### Silica

The resin composite material contains silica as inorganic filler. The silica may be any silica as long as it satisfies desired properties such as filling ratio into the resin, such as spherical silica or crushed silica. Such silicas may be used alone or in combination of two or more thereof. The silica preferably has a particle diameter of 0.1 μm or more and 4.0 μm or less.

The resin composition that is provided by curing the resin composite material preferably has a total content of cerium oxide and silica of 57 vol % or more. When this range is satisfied, a sufficient coefficient of linear expansion can be provided. From the viewpoint of the coefficient of linear expansion, the resin composition more preferably has a total content of cerium oxide and silica of 67 vol % or more.

### Additive

The resin composite material may optionally contain, in addition to the resin, cerium oxide, and silica, an additive. The additive may be any additive, such as curing accelerators, antioxidants, flame retardants, silane coupling agents, and plasticizers. Such additives may be used alone or in combination of two or more thereof.

### EXAMPLES

Hereinafter, specific examples and Examples will be described.

### Manufacturing Method

In order to provide a resin composition having a desired formulation, a resin, cerium oxide, silica, and an additive were weighed.

The resin employed as the main component was an alicyclic epoxy having high weatherability and a relatively low viscosity (“CELLOXIDE 8010” manufactured by Daicel Corporation), and the resin was mixed with a curing agent (“RIKACID MH-700G” manufactured by New Japan Chemical Co., Ltd.) in an amount equivalent to the epoxy equivalent. Subsequently, the resin, cerium oxide (“FG50” manufactured by TREIBACHER INDUSTRIE AG), and silica (“Sunseal” manufactured by Tokuyama Corporation) were stirred using a planetary rotational mixer such that the materials became uniform, to obtain a resin composite. The resin composite (resin composite material) was dropped on a 15 cm×15 cm flat mold provided with a 1 mm-thick spacer, and then sandwiched between the mold and another 15 cm×15 cm flat mold. This was heated using an electric furnace at 120° C. for 1 hour and then at 150° C. for 3 hours to achieve complete curing, to thereby obtain a 15 cm×15 cm, 1 mm-thick film of a resin composition.

### Evaluation Method

### Formulation Ratio

The obtained film of the resin composition was cut into a 5 cm×5 cm piece using a cutter to prepare a measurement sample for the formulation ratio. The formulation ratio was measured using an X-ray fluorescence spectrometer (XRF) (manufactured by Hitachi High-Tech Science Corporation). The surface of the prepared measurement sample was subjected to elemental mapping using the XRF, to locate the resin, cerium oxide, and silica. Subsequently, in the obtained map, the areas of the resin, cerium oxide, and silica were calculated. This operation was performed in four regions randomly selected on the surface of the measurement sample, and the areas of the resin, cerium oxide, and silica in the regions were individually averaged to obtain respective average areas. The average area of the resin was calculated in terms of its proportion to the total area of the map and was defined as the volume percent (vol %) of the resin; the average area of cerium oxide was calculated in terms of its proportion to the total area of the map and was defined as the volume percent (vol %) of cerium oxide; the average area of silica was calculated in terms of its proportion to the total area of the map and was defined as the volume percent (vol %) of silica.

### Radiation-Shielding Performance

The obtained film of the resin composition was cut into a 5 cm×5 cm piece using a cutter to prepare a measurement sample for radiation-shielding performance. The radiation-shielding performance was measured in accordance with JIS Z 4501:2011 at a tube voltage of 100 kV and evaluated in terms of lead equivalent (mmPb).

For example, the lead equivalent of radiation protective garments used in X-ray rooms in hospitals is known to range from 0.25 mmPb to 0.35 mmPb, and radiation protective garments having a lead equivalent of 0.25 mmPb or more are considered to have sufficient performance.

Thus, samples having a radiation-shielding performance of 0.35 mmPb or more were rated as “A” (i.e., Excellent); samples having a radiation-shielding performance of less than 0.35 mmPb and 0.25 mmPb or more were rated as “B” (i.e., Good); and samples having a radiation-shielding performance of less than 0.25 mmPb were rated as “C” (i.e., Poor).

### Coefficient of Linear Expansion

The obtained film of the resin composition was cut into a 1 cm×1 cm piece using a cutter to prepare a measurement sample for a coefficient of linear expansion. The coefficient of linear expansion was measured using a thermomechanical analyzer (TMA) (manufactured by TA Instruments). The temperature was increased from 0° C. to 150° C. at 10° C./min, held at 150° C. for 5 minutes, and then decreased from 150° C. to 0° C. at 10° C./min; this cycle was repeated three times; from the temperature profiles of the second cycle and the third cycle, the coefficient of linear expansion was calculated.

Aluminum alloys used for structural materials of aircraft, rockets, or the like are known to have a coefficient of linear expansion of about 24 ppm/K. When the resin composition according to the present disclosure is provided by application to a base material formed of such an aluminum alloy, the smaller the difference in the coefficient of linear expansion between the aluminum alloy serving as the base material and the resin composition, the less likely the resin composition is to experience breakage due to temperature fluctuations.

Thus, samples having a coefficient of linear expansion of 24 ppm/K or less were rated as “A” (i.e., Excellent); samples having a coefficient of linear expansion of more than 24 ppm/K and 31 ppm/K or less were rated as “B” (i.e., Good); and samples having a coefficient of linear expansion of more than 31 ppm/K were rated as “C” (i.e., Poor).

### Evaluation Results

### Example 1

The epoxy resin (3.8 g), 6.2 g of the curing agent, 149.7 g of cerium oxide, and 8.8 g of silica were weighed and the above-described manufacturing method was performed to obtain a film of a resin composition.

The obtained resin composition was measured using the XRF; as a result, the resin content was 25 vol %, the cerium oxide content was 63 vol %, the silica content was 12 vol %, and the total content of cerium oxide and silica was 75 vol %.

The radiation-shielding performance was measured to be 0.41 mmPb, indicating high radiation-shielding performance, and it was rated as “A“.

The coefficient of linear expansion was measured using the TMA and found to be 18.3 ppm/K, indicating a desirably low coefficient of linear expansion, and it was rated as “A”.

### Example 2

The epoxy resin (3.8 g), 6.2 g of the curing agent, 97.2 g of cerium oxide, and 7.2 g of silica were weighed and the above-described manufacturing method was performed to obtain a film of a resin composition.

The obtained resin composition was measured using the XRF; as a result, the resin content was 33 vol %, the cerium oxide content was 54 vol %, the silica content was 13 vol %, and the total content of cerium oxide and silica was 67 vol %.

The radiation-shielding performance was measured to be 0.35 mmPb, indicating high radiation-shielding performance, and it was rated as “A”.

The coefficient of linear expansion was measured using the TMA and found to be 23.8 ppm/K, indicating a desirably low coefficient of linear expansion, and it was rated as “A”.

### Example 3

The epoxy resin (3.8 g), 6.2 g of the curing agent, 85.8 g of cerium oxide, and 6.1 g of silica were weighed and the above-described manufacturing method was performed to obtain a film of a resin composition.

The obtained resin composition was measured using the XRF; as a result, the resin content was 36 vol %, the cerium oxide content was 52 vol %, the silica content was 12 vol %, and the total content of cerium oxide and silica was 64 vol %.

The radiation-shielding performance was measured to be 0.34 mmPb, indicating sufficient radiation-shielding performance, and it was rated as “B“.

The coefficient of linear expansion was measured using the TMA and found to be 25.8 ppm/K, indicating a sufficiently low coefficient of linear expansion, and it was rated as “B”.

### Example 4

The epoxy resin (3.8 g), 6.2 g of the curing agent, 93.4 g of cerium oxide, and 5.2 g of silica were weighed and the above-described manufacturing method was performed to obtain a film of a resin composition.

The obtained resin composition was measured using the XRF; as a result, the resin content was 35 vol %, the cerium oxide content was 55 vol %, the silica content was 10 vol %, and the total content of cerium oxide and silica was 65 vol %.

The radiation-shielding performance was measured to be 0.36 mmPb, indicating high radiation-shielding performance, and it was rated as “A”.

The coefficient of linear expansion was measured using the TMA and found to be 25.2 ppm/K, indicating a sufficiently low coefficient of linear expansion, and it was rated as “B”.

### Example 5

The epoxy resin (3.8 g), 6.2 g of the curing agent, 89.1 g of cerium oxide, and 15.3 g of silica were weighed and the above-described manufacturing method was performed to obtain a film of a resin composition.

The obtained resin composition was measured using the XRF; as a result, the resin content was 30 vol %, the cerium oxide content was 45 vol %, the silica content was 25 vol %, and the total content of cerium oxide and silica was 70 vol %.

The radiation-shielding performance was measured to be 0.29 mmPb, indicating sufficient radiation-shielding performance, and it was rated as “B”.

The coefficient of linear expansion was measured using the TMA and found to be 21.6 ppm/K, indicating a desirably low coefficient of linear expansion, and it was rated as “A”.

### Example 6

The epoxy resin (3.8 g), 6.2 g of the curing agent, 53.9 g of cerium oxide, and 7.7 g of silica were weighed and the above-described manufacturing method was performed to obtain a film of a resin composition.

The obtained resin composition was measured using the XRF; as a result, the resin content was 43 vol %, the cerium oxide content was 39 vol %, the silica content was 18 vol %, and the total content of cerium oxide and silica was 57 vol %.

The radiation-shielding performance was measured to be 0.25 mmPb, indicating sufficient radiation-shielding performance, and it was rated as “B”.

The coefficient of linear expansion was measured using the TMA and found to be 30.6 ppm/K, indicating a sufficiently low coefficient of linear expansion, and it was rated as “B”.

### Example 7

The epoxy resin (3.8 g), 6.2 g of the curing agent, 48.9 g of cerium oxide, and 7.3 g of silica were weighed and the above-described manufacturing method was performed to obtain a film of a resin composition.

The obtained resin composition was measured using the XRF; as a result, the resin content was 45 vol %, the cerium oxide content was 37 vol %, the silica content was 18 vol %, and the total content of cerium oxide and silica was 55 vol %.

The radiation-shielding performance was measured to be 0.24 mmPb, indicating insufficient radiation-shielding performance, and it was rated as “C”.

The coefficient of linear expansion was measured using the TMA and found to be 32.0 ppm/K, not indicating a sufficiently low coefficient of linear expansion, and it was rated as “C”.

### Example 8

The epoxy resin (3.8 g), 6.2 g of the curing agent, 43.2 g of cerium oxide, and 1.7 g of silica were weighed and the above-described manufacturing method was performed to obtain a film of a resin composition.

The obtained resin composition was measured using the XRF; as a result, the resin content was 55 vol %, the cerium oxide content was 40 vol %, the silica content was 5 vol %, and the total content of cerium oxide and silica was 45 vol %.

The radiation-shielding performance was measured to be 0.26 mmPb, indicating sufficient radiation-shielding performance, and it was rated as “B”.

However, the coefficient of linear expansion measured using the TMA was found to be 39.0 ppm/K, not indicating a sufficiently low coefficient of linear expansion, and it was rated as “C”.

### Example 9

The epoxy resin (3.8 g), 6.2 g of the curing agent, 52.0 g of cerium oxide, and 11.5 g of silica were weighed and the above-described manufacturing method was performed to obtain a film of a resin composition.

The obtained resin composition was measured using the XRF; as a result, the resin content was 40 vol %, the cerium oxide content was 35 vol %, the silica content was 25 vol %, and the total content of cerium oxide and silica was 60 vol %.

The radiation-shielding performance was measured to be 0.23 mmPb, indicating insufficient radiation-shielding performance, and it was rated as “C”.

The coefficient of linear expansion was measured using the TMA and found to be 28.5 ppm/K, indicating a sufficiently low coefficient of linear expansion, and it was rated as “B”.

### Example 10

The epoxy resin (3.8 g), 6.2 g of the curing agent, 32.4 g of cerium oxide, and 5.0 g of silica were weighed and the above-described manufacturing method was performed to obtain a film of a resin composition.

The obtained resin composition was measured using the XRF; as a result, the resin content was 55 vol %, the cerium oxide content was 30 vol %, the silica content was 15 vol %, and the total content of cerium oxide and silica was 45 vol %.

The radiation-shielding performance was measured to be 0.20 mmPb, indicating insufficient radiation-shielding performance, and it was rated as “C”.

The coefficient of linear expansion was measured using the TMA and found to be 38.9 ppm/K, not indicating a sufficiently low coefficient of linear expansion, and it was rated as “C”.

The formulation ratios and evaluation results of the materials in Examples 1 to 10 are summarized in Table 1. In Examples 1 to 6 and 8, the compositions have a cerium oxide content of 39 vol % or more. In Examples 1 to 10, the compositions have a cerium oxide content higher than the silica content. In Examples 1 to 7 and 9, the compositions have a total content of cerium oxide and silica higher than the resin content. In Examples 1 to 5, the compositions have a cerium oxide content higher than the resin content. In Examples 1 to 10, the compositions have a silica content lower than the resin content. In Examples 1 to 6 and 9, the compositions have a total content of cerium oxide and silica of 57 vol % or more. In Examples 1, 2, and 4, the compositions have a cerium oxide content of 54 vol % or more. In Examples 1, 2, and 5, the compositions have a total content of cerium oxide and silica of 67 vol % or more. In Examples 1 to 10, the compositions have a resin content of 55 vol % or less. In Examples 1 to 10, the compositions have a resin content of 25 vol % or more. In Examples 1 to 6, 7, and 9, the compositions have a resin content of 45 vol % or less. In Examples 1 to 10, the compositions have a silica content of 25 vol % or less. In Examples 1 to 10, the compositions have a silica content of 5 vol % or more.

TABLE 1

| | | | | Total of | Radiation- | | | |
|---|---|---|---|---|---|---|---|---|
| | | Cerium | | cerium oxide | shielding | | Coefficient of | |
| | Resin | oxide | Silica | and silica | performance | | linear expansion | |
| Example | [vol %] | [vol %] | [vol %] | [total vol %] | [mmPb] | | [ppm/K] | |
| Example | 25 | 63 | 12 | 75 | 0.41 | A | 18.3 | A |
| 1 | | | | | | | | |
| Example | 33 | 54 | 13 | 67 | 0.35 | A | 23.8 | A |
| 2 | | | | | | | | |
| Example | 36 | 52 | 12 | 64 | 0.34 | B | 25.8 | B |
| 3 | | | | | | | | |
| Example | 35 | 55 | 10 | 65 | 0.36 | A | 25.2 | B |
| 4 | | | | | | | | |
| Example | 30 | 45 | 25 | 70 | 0.29 | B | 21.6 | A |
| 5 | | | | | | | | |
| Example | 43 | 39 | 18 | 57 | 0.25 | B | 30.6 | B |
| 6 | | | | | | | | |
| Example | 45 | 37 | 18 | 55 | 0.24 | C | 32.0 | C |
| 7 | | | | | | | | |
| Example | 55 | 40 | 5 | 45 | 0.26 | B | 39.0 | C |
| 8 | | | | | | | | |
| Example | 40 | 35 | 25 | 60 | 0.23 | C | 28.5 | B |
| 9 | | | | | | | | |
| Example | 55 | 30 | 15 | 45 | 0.20 | C | 38.9 | C |
| 10 | | | | | | | | |

Note that the present disclosure is not limited at all to the above-described embodiments and Examples.

The resin composition of the present disclosure is also applicable to, instead of radiation-shielding members, for example, ultraviolet-shielding members and heat-insulating coating materials.

The present disclosure can provide a resin composition that can shield radiation and does not undergo peeling off or the like even under an environment with large temperature fluctuations.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-152107, filed Sep. 4, 2024, which is hereby incorporated by reference herein in its entirety.

What is claimed is:

1. A composition comprising:
a resin;
39 vol % or more cerium oxide; and
silica.

2. The composition according to claim 1, wherein a content of the cerium oxide is higher than a content of the silica.

3. The composition according to claim 1, wherein a total content of the cerium oxide and the silica is higher than a content of the resin.

4. The composition according to claim 1, wherein a content of the cerium oxide is higher than a content of the resin.

5. The composition according to claim 1, wherein a content of the silica is lower than a content of the resin.

6. The composition according to claim 1, wherein a total content of the cerium oxide and the silica is 57 vol % or more.

7. The composition according to claim 1, wherein a content of the cerium oxide is 54 vol % or more.

8. The composition according to claim 1, wherein a total content of the cerium oxide and the silica is 67 vol % or more.

9. The composition according to claim 1, wherein the cerium oxide has a particle diameter of 2.0 μm or more and 9.0 μm or less.

10. The composition according to claim 1, wherein the silica has a particle diameter of 0.1 μm or more and 4.0 μm or less.

11. The composition according to claim 1, wherein the resin is a cured resin.

12. A member comprising:
a base material; and
a film formed of the composition according to claim 1 on the base material.

13. The member according to claim 12, wherein the film has a film thickness of 1 mm or more.

14. The member according to claim 12, wherein the film has a coefficient of linear expansion of 31 ppm/K or less.

15. The member according to claim 12, wherein the base material is formed of an alloy.

16. The member according to claim 12, wherein the base material is formed of an aluminum alloy.

17. The member according to claim 12, having a radiation-shielding performance of 0.25 mmPb or more.

18. A structural material comprising the member according to claim 12.

19. An object comprising the member according to claim 12, wherein the object is an airplane, a satellite, an aircraft, or a rocket.

20. A protective garment comprising the member according to claim 12.
